(19) United States
(12) Patent Application Publication
(10) Pub. No.: US 2014/0129472 A1
(43) Pub. Date: May 8, 2014

(54) SYSTEM AND METHOD FOR ADMINISTRATING VOLUNTARY BENEFITS

(71) Applicant: Willis HRH, Nashville, TN (US)

(72) Inventor: Tim Stofka, Brentwood, TN (US)

(73) Assignee: WILLIS HRH, Nashville, TN (US)

(21) Appl. No.: 14/064,950

(22) Filed: Oct. 28, 2013

Related U.S. Application Data
(60) Provisional application No. 61/719,157, filed on Oct. 26, 2012.

(51) Int. Cl. G06Q 10/10

(52) U.S. Cl. CPC G06Q 10/1057
USPC 705/322

(57) ABSTRACT

A method and system for inegrating an Enterprise Resource Planning (ERP) system with a voluntary benefits source provider to enable a user to select voluntary benefits provided by the voluntary benefits source provider via the ERP system including providing interfacing software between the voluntary benefits source provider and the ERP system.

### CROSS REFERENCE TO RELATED APPLICATIONS

This application claims priority to U.S. Patent Application Ser. No. 61/719,157 filed Oct. 26, 2012 which is incorporated herein by reference in its entirety.

### COPYRIGHT NOTICE

A portion of the disclosure of this patent document contains material which is subject to copyright protection. The copyright owner has no objection to the facsimile reproduction by any one of the patent disclosure, as it appears in the U.S. Patent and Trademark Office patent files or records, but otherwise reserves all copyright rights whatsoever.

### FIELD OF THE INVENTION

The invention generally relates to voluntary benefits outsourcing systems and methods, and more particularly, to integrating voluntary benefits outsourcing systems with an employer's benefit systems.

### BACKGROUND OF THE INVENTION

Currently, employers typically provide a set of core benefits to their employees. These core benefits may include, but are not limited to, health insurance, life insurance, dental insurance, vision insurance, retirement plans, and/or 401(k) programs, for example. It is to be appreciated there is a significant expense for an employer to provide core benefits; not only the cost of the benefits themselves, but employers must also typically hire an employee(s) or outside consulting firm to manage the relationships with each individual benefits provider and to answer questions of the employees.

In addition to core benefits, employers may additionally provide voluntary benefits or optional benefits. Such benefits may not be paid for or subsidized by the employer but these benefits may be provided to employees of the company at a discounted cost by the benefit provider. Such voluntary benefits may be used to supplement the core benefits offered to employees, voluntary discounts may include for example, discounts for amusement parks, supplemental insurance programs, computer and computer accessories, books, mortgages, flowers, movie tickets and rentals, pet care and insurance, clothing and membership to consumer clubs. Employers may wish to provide access to these additional voluntary benefits to employees but there are direct costs for providing such benefits. Providing voluntary benefits, in addition to core benefits, provide an additional burden upon benefits coordinators who need to manage and understand the scope of the benefits, communicate this information to employees and coordinate selection of the benefits. Further, payroll departments must manage all the payroll deductions from each voluntary benefits provider and reflect each employee's use of the benefits on their paycheck. The time and costs of voluntary benefits limit the number of voluntary benefits employers may make available to employees.

Some public and private employers provide a broad array of both core and voluntary benefits to employees. Such employers at times have to regularly overhaul or even eliminate traditional core benefits to decrease expenses. Employers are increasingly trying to reduce the negative impact of such benefit cuts on employees by offering an ever-growing array of voluntary benefits individually selected and often paid for by employees themselves. Such voluntary benefits are generally offered at little or no cost to employers and save employees money over similar options available to the general public. These voluntary benefits may fill some important insurance gaps or provide essential services due to cuts in traditional or core benefits programs.

However, management of these core and voluntary benefits programs involves an increasingly significant time and monetary burden for employers. For instance, an employer typically utilizes an Enterprise Resource Planning (ERP) system for providing the aforesaid core benefits. Incorporation of voluntary benefits into an employer's ERP system requires such voluntary benefits products to be either hosted or linked to an outside source or vendor. It is noted hosted solutions have been disadvantageous in that a significant amount of time is required to build out voluntary benefits within an ERP system. And linked solutions are disadvantageous since linked solutions guide an employee outside of the familiarity of the ERP system which not only visually appear different than the enrollment process of the ERP system, but also requires the export of sensitive employee data outside of the trusted security confines of the ERP system.

Additionally, backend employer administration of voluntary benefits has also proven disadvantageous. For instance, following a benefits enrollment, current practices dictate the transfer of information between three entities—human resources, the insurance carrier, and the enrollment partner. While this method is operational, it requires that all data (e.g., file feeds, dependent eligibility files, deduction files) be transferred amongst these three parties outside of the employer's trusted ERP system, which can expose the process to error.

Hence, employers typically attempt to manage these benefits programs internally in their human resources departments as they did with the traditional or core benefits programs. Further, each employer must have a human resources department that includes employees knowledgeable about each of the benefits programs. As the number of benefits offered increases, managing these benefits becomes difficult and expensive. Thus, the cost of cutting core benefits is not fully realized.

It is also noted voluntary benefits programs may comprise a wide range of offerings including both pretax and post tax benefits. Employees receive a pay stub that includes a separate line item for each of the core and voluntary benefits that they select and must at least partially pay for. Managing payroll itself has become burdensome and is complicated by the myriad of benefits offerings.

Accordingly there exists a need for systems and methods of providing voluntary benefits outsourcing that is convenient and economical for employers and provides advantages for employees. There is also a need for systems and methods of providing voluntary benefits outsourcing that allows selection of a plurality of voluntary benefits to employees without significantly increasing a time and monetary burden on the employer while mitigating the possibility or data error due to data transfer and handling when using legacy systems and methods.

### SUMMARY OF THE INVENTION

The purpose and advantages of the invention will be set forth in and apparent from the description that follows. Additional advantages of the invention will be realized and attained by the devices, systems and methods particularly pointed out in the written description and claims hereof, as well as from the appended drawings.

To achieve these and other advantages and in accordance with the purpose of the invention, as embodied, the invention includes, in one aspect, a computer program for instructing a computer to perform the method of integrating an Enterprise Resource Planning (ERP) system with a voluntary benefits source provider. This enables a user to select voluntary benefits provided by the voluntary benefits source provider via the ERP system. This is achieved by providing interfacing software between the voluntary benefits source provider and the ERP system. In one embodiment, the interfacing software is adapted and configured to provide a data coupling to a plurality of voluntary benefits source providers wherein a user interfaces with the ERP system to select benefits provided by each of the plurality voluntary benefits source providers. In one aspect the interfacing software utilizes XML-based 128-bit secure web calls.

It is noted an advantage of this embodiment of the present invention is the elimination or mitigation of data error by establishing a secure and trusted connection between an ERP system and a voluntary benefits source provider through which data can be transferred in real time. Another noted advantage is the provision of employee access to voluntary benefits via a integrated connection to a voluntary benefits carrier interface while using an employee's ERP system.

### BRIEF DESCRIPTION OF THE DRAWINGS

The accompanying appendices and/or drawings illustrate various non-limiting, example, inventive aspects in accordance with the present disclosure:

FIG. 1 illustrates an exemplary computer system which may be used with certain components of illustrated embodiments of the invention;

FIG. 2 depicts a simplified systematic view of an illustrated embodiment; and

FIG. 3 depicts a system overview and data-flow in accordance with the illustrated embodiment of FIG. 2.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims.

In accordance with the below illustrated embodiment of the present invention, what is provided is a solution for integrating carriers associated with voluntary benefits with an employers ERP system for managing voluntary benefits programs for employers. Embodiments of the voluntary benefits outsourcing system and method further provide a more economical means of providing additional benefits to employees. The system provides a communication method for enabling such integration with an ERP system facilitating an employee to access and select voluntary benefits directly from the ERP interface.

From what will become apparent from the below description of the illustrated embodiment(s) of the present invention, other noted advantages and features include the ability to incorporate voluntary benefits into an employee's benefit plan offering without having to build out products within the ERP system or S provide a link to an outside benefits platform. Thus, fluidity of user experience is preserved as they will not leave the ERP to enroll in benefits, as is the ease of use whereby answers to questions are pre-filled based on data stored in the ERP. Further automation of post-enrollment administrative processes is provided which includes deduction files, change files, and beneficiary/dependent alterations. Additionally, a solution is provided to problems associated with benefits implementation after the first year (e.g., plan design changes, rate table changes, increases in guaranteed issue coverage when an insured's cross age bands, life event changes and the like).

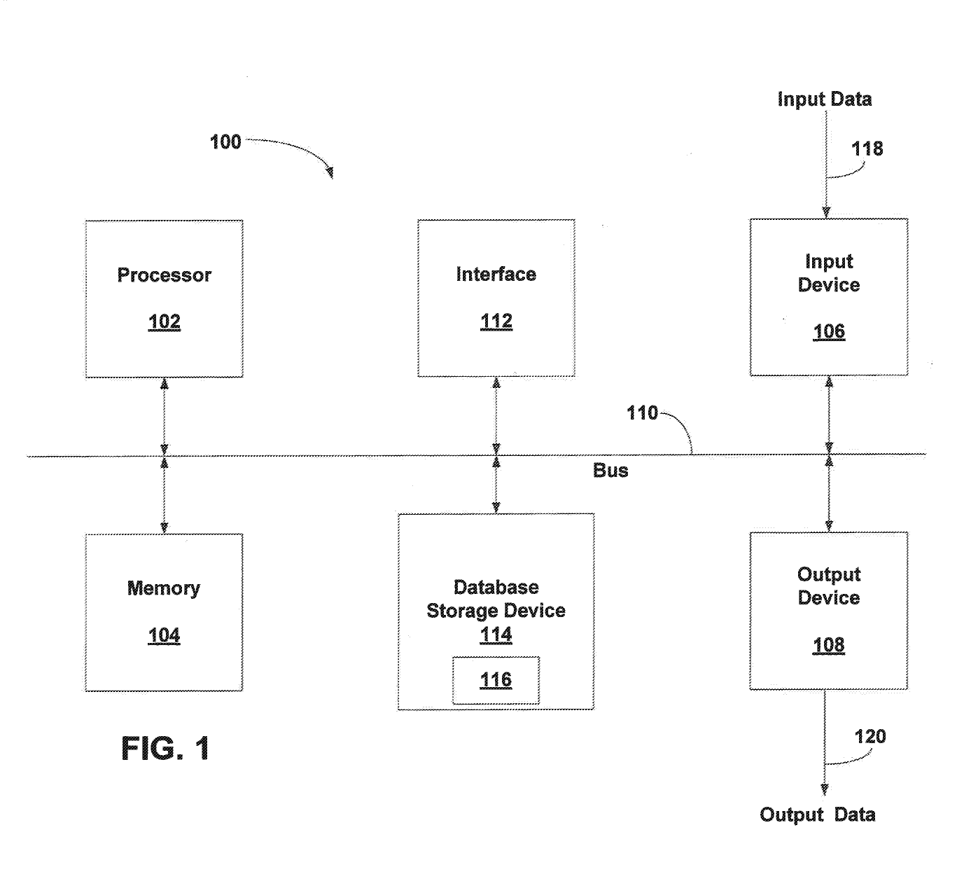

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, touch-screen, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source. Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, tablet devices, smart phone devices, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

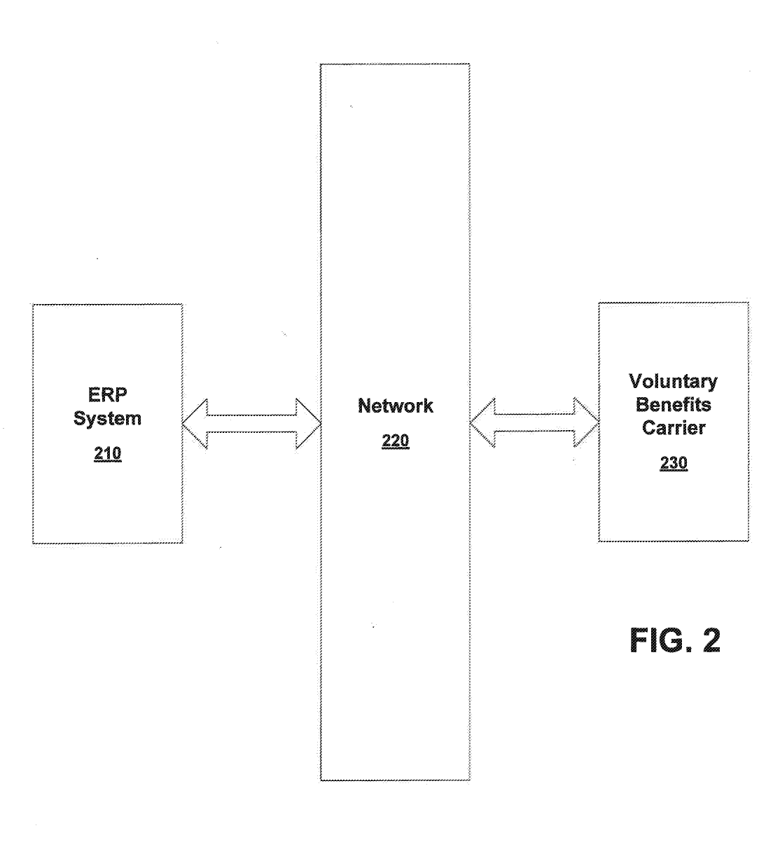

With the exemplary computing system environment 100 of FIG. 1 being generally shown and discussed above, depicted in FIG. 2 is simplified systematic diagram of an illustrated embodiment of the present invention. What is generally shown is an ERP system 210 coupled via a network 220 (e.g., the Internet, LAN, WAN, and other suitable networking means) to an outsourcing insurance carrier system 230. Examples of such an ERP system 210 (and which are not to be limited thereto) are provided by PeopleSoft™, Lawson™, Oracle™ EBS, Workday™ and SAP™. Examples of such an outsourcing insurance carrier system 230 (and which are not to be limited thereto) include Unum™, Allstate™, ING™, Boston Mutual™, Texas Life™, Humana™, Aflac™, TransAmerica™, Lincoln Financial™ and American General™.

In accordance with the illustrated embodiment of FIG. 2, the ERP system 210 includes a software module configured and adapted to interact with an insurance carrier's 230 application system preferably through multiple XML-based, 128-bit secure web service calls. For example, after providing an insurance carrier's system 230 with the demographic, beneficiary, dependent, and other pertinent information stored in the ERP system 210, the present invention leverages the technological strength of the ERP 210 to render carrier-provided marketing material, audiovisual aids, and benefit quoting directing to an employee using the ERP system 210.

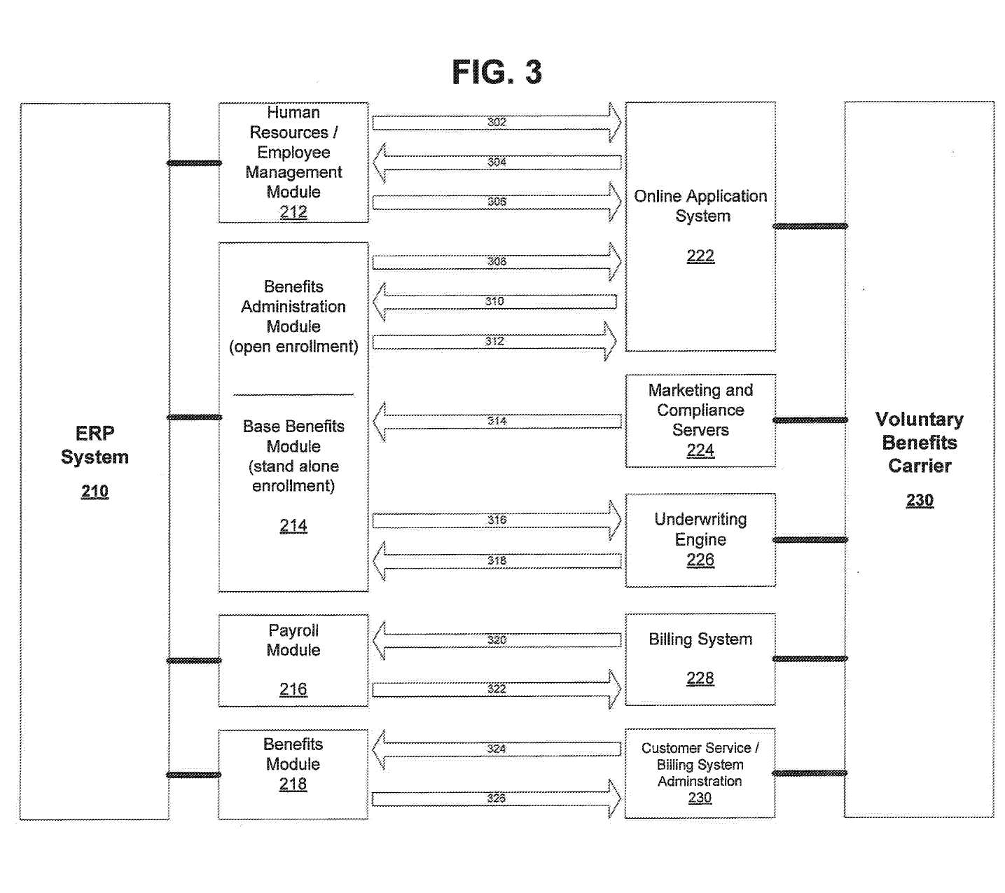

With reference now to the system overview and data-flow diagram of FIG. 3 (and with containing reference to FIG. 2), described below is operation of the present invention for enabling an employee to select voluntary benefits directly from the ERP system 210 in accordance with the illustrated embodiment. Starting at step 302, and with an employee preferably accessing a Human Resources/Employee Management Module 212 of the ERP system 210, employer identification information (e.g., employer identification, a request for a unique session ID) is sent to an application system 222 associated with the carrier system 220. It is to be appreciate application system 222 is preferably exposed to web services. In response and upon proper verification, the application system 222 preferably sends a unique session ID to the Human Resources/Employee Management Module 212 of the ERP system 210 (step 304). Upon receiving the unique session ID, the Human Resources/Employee Management Module 212 preferably sends information relating to the employee (e.g., employee company, job data, dependents/beneficiaries, and the like) to the application system 222 of the carrier system 220 (step 306).

Next, the employee preferably accesses a Benefits Administration Module 214 of the ERP system 210 (e.g.; during an open enrollment process or stand alone enrollment process) to request information (e.g., coverage levels, premium information and the like) relating to certain voluntary benefit products offered by the carrier 230 (step 308). In return, and dependent upon the information regarding the employee (step 306), the application system 222 of the carrier system 220 provides this requested information regarding a selected voluntary benefit product (e.g., benefit rates, rules, compliance regulations, application questions, an application statement and the like) (step 310). The employee upon review of this information is provided a quote for the aforesaid voluntary benefit products offered by the carrier 230 (step 312).

Upon the delivery of the aforesaid quote (step 310), preferably a marketing and compliance server 224 associated with the carrier system 220 provides the requested application material (e.g., marketing language, audio/visual information State specific application documents, and the like) to the Administration Module 214 of the ERP system 210 (step 314). This enables the employee to review this material and complete the application relating to a certain voluntary benefit product offered by the carrier 230. Once the application is completed in the ERP system 210, the completed application is sent from the ERP system 210 to preferably an underwriting engine/module 226 associated with the carrier system 220 (step 316). The underwriting engine/module 226 then processes the completed application to determine acceptance or denial based upon prescribed thresholds and preferably provides this decision to the benefits Administration Module 214 of the ERP system 210 (step 318).

In the event the underwriting engine/module 226 accepts the employee's aforesaid application, a billing system module 228 associated with the carrier system 220 preferably provides employee payroll deduction information (e.g., payroll deduction amount, start date, applicable benefit codes and the like) to a payroll module 216 associated with the ERP system 210 regarding the now subscribed certain voluntary benefit product offered by the carrier 230 and as selected by the employee (step 320). Thus, at a certain time period/interval, the payroll module 216 performs the appropriate payroll deduction from the employee and remits this payroll deduction preferably to the billing system 228 so as to be received within the accounts payable department of the carrier system 220 regarding the enrolled certain voluntary benefit product (step 322).

In the event an employee desires to make changes (e.g., life event elections, policy changes) to an enrolled product offered by the carrier system 220, the employee preferably utilizes a benefits module 218 of the ERP system 210 to notify a customer service billing system administration module 230 associated with the carrier system 220 of such changes (step 324). Upon the processing of this change request information, notification is sent back to the benefits module indicating such changes (e.g., benefit terminations, beneficiary updates, address updates and the like) (step 326).

With the process for selecting voluntary benefits being described above, it is to be appreciated that certain above articulated steps described in conjunction with FIG. 3, may be optional. The steps described in conjunction with FIG. 3 are also to be understood to be merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for integration of voluntary benefits offered by third party carrier systems with an ERP system, it is to be understood that various other adaptations and modifications may be made within the spirit and scope of the embodiments herein. Further, and in this regard, the foregoing description has been directed to specific illustrated embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A computer program for instructing a computer to perform the method of integrating an Enterprise Resource Planning (ERP) system with a voluntary benefits source provider to enable a user to select voluntary benefits provided by the voluntary benefits source provider via the ERP system, comprising the step of providing interfacing software between the voluntary benefits source provider and the ERP system.

2. A computer program as recited in claim 1 wherein the interfacing software is adapted and configured to couple with a plurality of voluntary benefits source providers wherein a user interfaces with the ERP system to select benefits provided by each of the plurality voluntary benefits source providers.

3. A computer program as recited in claim 1 wherein the interfacing software utilizes XML-based 128-bit secure web calls.
